(19) United States
(12) Patent Application Publication
(10) Pub. No.: US 2014/0279868 A1
(43) Pub. Date: Sep. 18, 2014

(54) System and Method for Generating an Informational Packet for the Purpose of Marketing a Vehicle to Prospective Customers

(71) Applicant: Autoipacket, LLC, Chantilly, VA (US)

(72) Inventors: Paul Astorg, Parkersburg, WV (US); Seve P. Astorg, Parkersburg, WV (US); Kenneth S. Wilkinson, Parkersburg, WV (US)

(73) Assignee: Autoipacket, LLC, Chantilly, VA (US)

(21) Appl. No.: 14/212,755

(22) Filed: Mar. 14, 2014

Related U.S. Application Data
(60) Provisional application No. 61/783,703, filed on Mar. 14, 2013.

(51) Int. Cl. G06F 17/30

(52) U.S. Cl. CPC G06F 17/30312
USPC 707/609; 707/741

(57) ABSTRACT

System and method for collecting information including data and files about a vehicle in a central repository, such data including inventory data from automobile dealerships, service history data, ownership history data, warranty data, original factory equipment data, invoice pricing data, vehicle images, financing data, and current retail value data, normalizing this data, and aggregating and storing the data in an relational database and file system to permit creation of customized presentations and analytical reports to assist in marketing vehicles to perspective customers.

This patent application claims priority to U.S. Patent Application No. 61/783,703 filed on Mar. 14, 2013 and entitled “System and Method for Generating an Informational Packet for the Purpose of Marketing a Vehicle to Prospective Customers”, which is hereby incorporated by reference.

### I. FIELD OF THE INVENTION

This invention in at least one embodiment relates to a system and method for generating an information packet about at least one vehicle for the purpose of marketing the at least one vehicle to at least one prospective customer. In other embodiments, this invention relates to a system and method for providing additional insight into marketing metrics for, for example, individual items, items categories, salespeople, departments, locations, and company wide.

### II. SUMMARY OF THE INVENTION

The invention in at least one embodiment includes a system and/or method for collecting various aspects of vehicle data including inventory data from automobile dealerships, service history data, ownership history data, warranty data, original factory equipment data, invoice pricing data, vehicle images, financing data, and current retail value data, normalizing this data, and aggregating and storing the data in an relational database and file system in order to create customized presentations and analytical reports to help market vehicles to prospective customers. The system in at least one embodiment provides all available information about a vehicle in a central repository allowing users to remotely access all available information about a vehicle quickly and be able to present this data in a customizable and meaningful way through an in-person presentation, via email communication, or via text messaging (or SMS). The system in a further embodiment also confirms that all information is up-to-date, which ensures data accuracy while in a further embodiment preferences are used to determine which data source is to be given more credence when there is a disagreement in the information.

The invention in at least one embodiment includes a method for assimilating information for a plurality of vehicles from a plurality of sources to present to at least one person using a system having at least one processor and a relationship database, the method including: searching the relationship database for active vehicles; for each vehicle: determining whether the relationship database has images for the located vehicle, when a vehicle has no images associated with it, querying the relationship database for a source and obtaining images if available from that source, determining whether the vehicle is a certified pre-owned vehicle, when a vehicle is a certified pre-owned vehicle, loading a set of data categories for certified pre-owned vehicles into an array to perform an iterative loop through that array to obtain and/or update information in those data categories, querying the relationship database for system data categories to load into a second array to perform an iterative loop through that array to obtain and/or update information in those data categories, querying the relationship database for data categories for a dealership associated with the vehicle to load into a third array to perform an iterative loop through that array to obtain and/or update information in those data categories including retrieving any stored content to create presentation material using predefined templates.

The invention in at least one embodiment includes a method for assimilating information for a plurality of vehicles from a plurality of sources to present to at least one person using a system having at least one processor and a relationship database, the method including: searching the relationship database for active vehicles; for each vehicle querying the relationship database for data categories to load into an array to perform an iterative loop through that array to get and/or update information in those data categories; wherein the iterative loop includes looping through the array from 1 to n where n equals the number of data categories in the array, for each loop determine whether the array end has been reached, when the array end is reached progressing to the next query step or end of said method; querying the relationship database to determine if content is present for the data category; when no content is present in the relationship database, retrieving content from a source, storing the content into the relationship database and/or the file system then returning to the start of the loop; when content is present in the relationship database, determining whether there is newer content available; when newer content is available, retrieving newer content from a source, storing the newer content into the relationship database and/or the file system then returning to the start of the loop; and when newer content is not available, returning to the start of the loop.

Further to any of the above embodiments, the method further includes: retrieving an inventory data feed from an external source; reviewing each vehicle in the inventory data feed; for each vehicle determining whether the data formats are equivalent; when the data formats are not equivalent, translating the unequal data formats; determining whether the vehicle is present in the relationship database; when the vehicle is not present, assigning a new identification for the vehicle and creating a record for the vehicle in the relationship database, then proceeding to the next vehicle in the inventory data feed; when the vehicle is present, determining whether the data values are equal; when the data values are not equal, determining which data value to use, then proceeding to the next vehicle in the inventory data feed; and when the data values are equal, then proceeding to the next vehicle in the inventory data feed.

Further to any of the above embodiments, the method further includes: receiving a request for vehicle information; determining whether the request includes at least one vehicle identifier; when multiple identifiers are received, submitting multiple queries to the relationship database using the possible vehicle identifiers and joining the query results together; when a single identifier is received, submitting a single query to the relationship database; determine whether more than one vehicle has been located; when more than one vehicle is located, displaying an inventory page including the located vehicles and receiving a selection from the user of one vehicle; and when one vehicle is located or selected, then loading any data categories into a loop array, and looping over the loop array to return content to a user interface with a label for each data category that is available and includes content. Further to the previous embodiment, where the user is not associated with the dealership; and determining the level of access based on whether the user is registered with the system and preferences of the dealership. In an alternative embodiment, assembling any multiple criteria into a single search query.

Further to any of the above embodiments, the method further includes: receiving a user selection of at least one selected vehicle for communication of a packet to a third party; querying the relationship database to learn available data categories for the at least one selected vehicle and providing the available data categories for each vehicle to the user for selection; receiving contact information for the third party and a selection of data categories to send to the third party as part of the packet; validating the contact information; looping over a packet array containing the selected data categories; for each data category retrieving any data for the data category, retrieving content present in the file system for data categories having file system content and merging the content into the packet, and proceeding to next data category in the packet array if any; and sending the packet to the third party. Further to the previous embodiment adding a data record into a packet_share data table in the relationship database proximate the packet being sent to include the third party that the packet was sent to for use in analytical reports. Further to either of the previous embodiment, adding or updating the data record in the packet_share data table when the third party views the packet for at least a first time. Further to the previous embodiment, sending a notification from the packetshare manager module to the user when the third party views the packet via at least one of text and e-mail. Further to any of the previous four embodiments, where the packet is transmitted as a PDF or a link to the information where the information displayed with the link is the current information (in an alternative embodiment, the information is as it was when the link was sent). Further to the other embodiments in this paragraph, when the customer is not present in the customer data table (or at least not affiliate with the store and/or company), the customer manager module requesting contact information for the third party from the user, receiving contact information for the third party from the user, adding a data record in the customer data table for the third party, and proceeding to looping over the packet array. When the request for the packet originates with an external website, a service, and/or the public, sending a notification to the store that a packet has been sent.

Further to any of the above embodiments, the method further including displaying with the packet manager module data categories that the user has authorization to view based on information contained in said relationship database.

The invention according to at least one embodiment includes a system including: a relationship database; a file system storage; a plurality of backend components in communication with said relationship database and said file system storage, at least one backend component is in communication with an external data source, each backend component includes a manager sub-module, a gateway sub-module in communication with said manager sub-module, and a data access object sub-module in communication with said manager sub-module and at least one of said relationship database and said file system storage; and a plurality of frontend components in communication with said plurality of said backend components and in communication with said relationship database and said file system storage through at least one backend component. Further to the previous embodiment, the plurality of backend components includes a company manager module in communication with said file system storage and said relationship database; a user manager module in communication with said relationship database; a store manager module in communication with said file system storage and said relationship database; a data categories manager module in communication with said file system storage and said relationship database; an audiovisual manager module in communication with said file system storage and said relationship database; a packet manager module in communication with said file system storage and said relationship database; a vehicle manager module in communication with said file system storage and said relationship database; a file manager module in communication with said file system storage and said relationship database; a packetshare manager module in communication with said file system storage and said relationship database; a customer manager module in communication with said relationship database; and an email manager module in communication with said relationship database. Further to either of the previous embodiments, the plurality of frontend components include a tools module in communication with said audiovisual manager module, said data categories manager module, said packet manager module, said vehicle manager module, and said file manager module; a company module in communication with said company manager module and said user manager module; a store module in communication with said store manager module and said user manager module; a customer module in communication with said customer manager module; a packet module in communication with said data categories manager module, said packet manager module, said packetshare manager module, and said email manager module; a report module in communication with said vehicle manager module, said packet manager module, said data categories manager module, said file manager module, and said packetshare manager module; a user module in communication with said user manager module, said user module provides system authentication; and a dashboard module connected to at least a majority of the said plurality of backend components. Further to either of the first two embodiments of this paragraph, the plurality of frontend components include a tools module; a company module; a store module; a customer module; a packet module; a report module; a user module; and a dashboard module. Further to either of the previous two embodiments, the packet module provides an interface for an user to view a packet, send a packet, print a packet, view a packet send history, and view packet listings, said packet module communicates with said packet manager module, said packetshare manager module and said email manager module to send a packet to an email address, said packetshare manager module updates a packet_share data table in said relationship database proximate to a time a packet is emailed. Further to the previous embodiment, the packetshare manager notifies the packet sender as determined by a data entry in a user data table in the relationship database when the packet is reviewed by a recipient of the email.

The further to any of the embodiment in the previous paragraph, the relationship database includes a plurality of interconnected data tables for storing customer, vehicle, company, store, users, packets for each vehicle, data categories, and file pointers to said file system storage. The further to any of the embodiment in the previous paragraph, the relationship database includes a store data table; a vehicle data table linked to said store data table; a store data categories data table linked to said store data table; a data categories data table linked to said store data categories data table; a packet data table linked to said store data table and said vehicle data table; a store data categories files data table; a system data categories files data table; a packet data categories data table linked to said data categories data table, said packet data table, said store data categories files data table, and said system data categories files data table; and a file pointers data table linked to said packet data categories data table, said file pointers data table including data records with file locations in said file system storage.

The invention according to at least one embodiment includes a system for vehicle information input, storage, and retrieval where the vehicle is for sale at a dealership where the system includes a relationship database; means for data collection from a plurality of sources including third party data resources, the vehicle manufacturer's computer system, a dealership management system, and a dealership's website hosting provider; means for data normalization of data obtained from the plurality of sources so that the data can be stored in the relationship database and associated with at least one vehicle; means for data aggregation and storage in the relationship database using a plurality of keys to define relationships between data records and associating files to at least one data record; means for data presentation to a user of the data associate with at least one vehicle; and means for data communication of an information packet to potential consumers where the informational packet includes information regarding one vehicle that is selected by the user.

Further to the previous embodiment, the data sent to one of the potential consumers has information about a vehicle obtained from a dealership management system or vendor of the dealership including information retrieved from a vehicle manufacturer's computer systems, a vehicle on-board computer, service history data, ownership history data, warranty data, original factory equipment data, invoice pricing data, vehicle images, financing data, current retail value data, vehicle description, inspection report, repair order history, disclosure report, warranty information, retail reports, history reports, MSRP, financing options, and dealership information.

Given the following enabling description of the drawings, the system and method should become evident to a person of ordinary skill in the art.

### III. BRIEF DESCRIPTION OF THE DRAWINGS

The present invention is described with reference to the accompanying drawings. In the drawings, like reference numbers indicate identical or functionally similar elements. The use of cross-hatching (or lack thereof) and shading within the drawings is not intended as limiting the type of materials that may be used to manufacture the invention.

FIG. 1 illustrates a schematic example of a cloud computing node.

FIG. 2 illustrates an example of a cloud computing environment according to at least one embodiment of the invention.

FIG. 3 illustrates a set of functional abstract layers provided by a cloud computing environment according to at least one embodiment of the invention.

FIGS. 4A-4C illustrate a set of block diagrams for a system according to at least one embodiment of the invention. FIG. 4D illustrates an example database configuration according to at least one embodiment of the invention. FIG. 4E illustrates a portion of the example database illustrated in FIG. 4D.

FIGS. 5A and 5B illustrate flow diagrams for a method according to at least one embodiment of the invention. FIG. 5C illustrates an alternative embodiment to the flow diagram illustrated in FIG. 5A.

FIGS. 6A-6E illustrate a flow diagram for a method according to at least one embodiment of the invention.

FIG. 7 illustrates a flow diagram for a method according to at least one embodiment of the invention.

FIG. 8 illustrates a flow diagram for a method according to at least one embodiment of the invention.

FIG. 9 illustrates a flow diagram for a method according to at least one embodiment of the invention.

FIG. 10 illustrates a flow diagram for a method according to at least one embodiment of the invention.

FIG. 11A illustrates a flow diagram for a method according to at least one embodiment of the invention. FIG. 11B depicts part of an inventory listing interface according to at least one embodiment of the invention. FIG. 11C depicts an example interface according to at least one embodiment of the invention.

FIG. 12A illustrates a flow diagram for a method according to at least one embodiment of the invention. FIG. 12B depicts an example interface according to at least one embodiment of the invention.

FIG. 13 illustrates a flow diagram for a method according to at least one embodiment of the invention.

FIG. 14A-14B illustrate a flow diagram for a method according to at least one embodiment of the invention.

FIG. 15 illustrates an example hierarchy for a system implementation according to at least one embodiment of the invention.

FIGS. 16A-16B illustrate a block diagram of an alternative system embodiment according to the invention.

FIGS. 17A-17F illustrate different example interfaces for use in conjunction with at least one embodiment according to the invention.

FIG. 18 illustrates a computer program product and computer implementation according to at least one embodiment of the invention.

### IV. DETAILED DESCRIPTION OF THE DRAWINGS

Based on this disclosure it should be understood that although this disclosure discusses a detailed description on cloud computing, implementation of what is taught in this disclosure is not limited to a cloud computing environment. Instead, various embodiments of the present invention are capable of being implemented together with any other computing environment now known or later developed.

Cloud computing is a model for enabling convenient, on-demand network access to a shared pool of configurable computing resources (e.g., networks, servers, storage, applications, and services) that can be rapidly provisioned and released with minimal management effort or customer/consumer interaction with a provider of the service. The cloud model may include at least five characteristics, at least three service models, and at least four deployment models.

The characteristics include, for example but not limited to, on-demand self-service, broad network access, resource pooling, rapid elasticity, and measured service.

On-Demand Self-Service.

A consumer can unilaterally provision computing capabilities, such as server time and network storage, as needed automatically without requiring human interaction with each service provider.

Broad Network Access.

Capabilities are available over the network and accessed through standard mechanisms that promote use by heterogeneous thin or thick client platforms (e.g., mobile phones, tablets, laptops, and workstations).

Resource Pooling.

The provider's computing resources are pooled to serve multiple consumers using a multi-tenant model, with different physical and virtual resources dynamically assigned and reassigned according to consumer demand. There is a sense of location independence in that the customer generally has no control or knowledge over the exact location of the provided resources but may be able to specify location at a higher level of abstraction (e.g., country, state, or datacenter). Examples of resources include storage, processing, memory, and network bandwidth.

Rapid Elasticity.

Capabilities can be elastically provisioned and released, in some cases automatically, to scale rapidly outward and inward commensurate with demand. To the consumer, the capabilities available for provisioning often appear to be unlimited and can be appropriated in any quantity at any time.

Measured service. Cloud systems automatically control and optimize resource use by leveraging a metering capability at some level appropriate to the type of service (e.g., storage, processing, bandwidth, and active user accounts). Resource usage can be monitored, controlled, and reported, providing transparency for both the provider and consumer of the utilized service. Examples of metering capability include a pay-per-use or charge-per-use basis; however, other possible metering approaches could be used instead.

Examples of service models include, but are not limited to, Software as a Service (Saas), Platform as a Service (PaaS), and Infrastructure as a Service (IaaS).

Software as a Service (SaaS).

The capability provided to the consumer is to use the provider's applications running on a cloud infrastructure. The applications are accessible from various client devices through either a thin client interface, such as a web browser or a program interface. The consumer does not manage or control the underlying cloud infrastructure including network, servers, operating systems, storage, or even individual application capabilities, with the possible exception of limited user-specific application configuration settings.

A cloud infrastructure is a collection of hardware and software that enables the five characteristics of cloud computing. The cloud infrastructure can be viewed as containing both a physical layer and an abstraction layer. The physical layer includes the hardware resources that are necessary to support the cloud services being provided, and typically includes server, storage and network components. The abstraction layer includes the software deployed across the physical layer, which manifests the essential cloud characteristics. Conceptually the abstraction layer sits above the physical layer.

Platform as a Service (PaaS).

The capability provided to the consumer is to deploy onto the cloud infrastructure consumer-created or acquired applications created using programming languages, libraries, services, and tools supported by the provider. This capability does not necessarily preclude the use of compatible programming languages, libraries, services, and tools from other sources. The consumer does not manage or control the underlying cloud infrastructure including network, servers, operating systems, or storage, but has control over the deployed applications and possibly configuration settings for the application-hosting environment.

Infrastructure as a Service (IaaS).

The capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, and deployed applications; and possibly limited control of select networking components (e.g., host firewalls).

Examples of Deployment Models include, but are not limited to, private cloud, community cloud, public cloud and hybrid cloud.

Private Cloud.

The cloud infrastructure is provisioned for exclusive use by a single organization having multiple consumers (e.g., business units). It may be owned, managed, and operated by the organization, a third party, or some combination of them, and it may exist on or off premises.

Community Cloud.

The cloud infrastructure is provisioned for exclusive use by a specific community of consumers from organizations that have shared concerns (e.g., mission, security requirements, policy, and compliance considerations). It may be owned, managed, and operated by one or more of the organizations in the community, a third party, or some combination of them, and it may exist on or off premises.

Public Cloud.

The cloud infrastructure is provisioned for open use by the general public. It may be owned, managed, and operated by a business, academic, or government organization, or some combination of them. It exists on the premises of the cloud provider.

Hybrid Cloud.

The cloud infrastructure is a composition of two or more distinct cloud infrastructures (private, community, or public) that remain unique entities, but are bound together by standardized or proprietary technology that enables data and application portability (e.g., cloud bursting for load balancing between clouds).

A cloud computing environment allows for the providing of services to customers while providing a level of flexibility based on use requirements. Cloud computing is thought of as providing a network having a plurality of interconnected nodes.

Referring now to FIG. 1, a schematic of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth herein.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. See, e.g., FIG. 2.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As illustrated in FIG. 1, computer system/server 110 in cloud computing node 100 is shown in the form of a general-purpose computing device. The components of computer system/server 110 may include, but are not limited to, one or more processors (or processing units) 112, a system memory 130, and a bus 116 that couples various system components including system memory 130 to processor 112.

Bus 116 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media.

Examples of system memory 130 include but are not limited to computer system readable media in the form of volatile memory, such as cache memory 134 and/or random access memory (RAM) 136. Computer system/server 110 may further include other removable/non-removable, volatile/non-volatile computer system storage media. By way of example only, storage system 132 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 116 by one or more data media interfaces. As will be further described below, memory 130 may include at least one program product having a set (e.g., at least one) of program modules that are configured to carry out the functions of embodiments of the invention.

Program/utility 138, having a set (at least one) of program modules 139, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 139 generally carry out the functions and/or methodologies of embodiments of the invention as described herein.

Computer system/server 110 may also communicate with one or more external devices 140 such as a keyboard, a pointing device such as a mouse, a display 150, etc.; one or more devices that enable a user to interact with computer system/server 110; and/or any devices (e.g., network card, modem, etc.) that enable computer system/server 110 to communicate with one or more other computing devices. Such communication can occur via Input/Output (I/O) interfaces 114. Computer system/server 110 can also communicate in at least one embodiment with one or more networks such as a local area network (LAN), a general wide area network (WAN), and/or a public network (e.g., the Internet) via network adapter 118. As illustrated, network adapter 118 communicates with the other components of computer system/server 110 via bus 116. It should be understood that although not shown, other hardware and/or software components could be used in conjunction with computer system/server 110. Examples, include, but are not limited to: microcode, device drivers, redundant processing units, external disk drive arrays, RAID systems, tape drives, and data archival storage systems, etc.

FIG. 2 illustrates a cloud computing environment 210 that includes one or more cloud computing nodes 100 (the nodes and interconnections are offered as an example of cloud computing nodes) with which local computing devices used by cloud consumers, such as, for example, a cellular telephone (or smartphone or personal digital assistant (PDA)) 220, a laptop computer 221, a desktop computer 222, a tablet 223, an automobile (or vehicle) computer system 224, a dealership management system 225, external data sources 226, and/or a kiosk 227 may communicate. In any particular implementation, one or more of the example local computing devices may be omitted. An example of the automobile computer system is the one or more computers present in a vehicle such as those providing diagnostic information, controlling different aspects of the vehicle, and providing a user interface(s) and/or information to the vehicle occupants. The dealership management system (DMS) 225 in at least one embodiment includes inventory and/or maintenance/service records for a particular dealership(s). Examples of external data sources 226 include but are not limited to websites identifying vehicles for sale at a dealership(s), aggregation services containing information regarding the history of the vehicle such as CarFax, manufacturer records regarding the vehicle, lenders, and vehicle appraisal services. An example of a kiosk 227 is a platform present at a dealership for customers to interact with the system.

In at least one embodiment, individual nodes 100 may communicate with one another. The nodes 100 may be grouped (not shown) physically or virtually, in one or more networks, such as Private, Community, Public, or Hybrid clouds as described hereinabove, or a combination thereof. This allows cloud computing environment 210 to offer infrastructure, platforms and/or software as services for which a cloud consumer does not need to maintain resources on a local computing device 220-223, 225, 227. It is understood that the types of computing devices 220-227 illustrated in FIG. 2 are intended to be illustrative only and that computing nodes 100 and cloud computing environment 210 can communicate with any type of computerized device over any type of network and/or network addressable connection (e.g., using a web browser).

FIG. 3 illustrates a set of functional abstraction layers provided by cloud computing environment 210, which is illustrated, for example, in FIG. 2. It should be understood based on this disclosure that the components, layers, and functions illustrated in FIG. 3 are intended to be illustrative only and embodiments of the invention are not limited thereto. As illustrated, the following layers and corresponding functions are provided:

The hardware and software layer 310 includes hardware and software components. Examples of hardware components include but are not limited to mainframes, RISC (Reduced Instruction Set Computer) architecture based servers and other server types, storage devices, networks and networking components. Examples of software components include but are not limited to network application server software and database software.

The virtualization layer 320 provides an abstraction layer from which virtual entities may be provided. Examples of the virtual entities include but are not limited to virtual servers; virtual storage; virtual networks including virtual private networks; virtual applications and operating systems; and virtual clients.

In at least one embodiment, the management layer 330 may provide the functions described below. Resource provisioning 331 provides dynamic procurement of computing resources and other resources that are utilized to perform tasks within the cloud computing environment. Metering and Pricing 332 provide cost tracking as resources are utilized within the cloud computing environment, and billing or invoicing for consumption of these resources. In one example, these resources may include but are not limited to application software licenses. Security 333 provides identity verification for cloud consumers and tasks, as well as protection for data and other resources. User portal 334 provides access to the cloud computing environment for consumers and system administrators. Service level management 335 provides cloud computing resource allocation and management such that required service levels are met. Service Level Agreement (SLA) planning and fulfillment 336 provides pre-arrangement for, and procurement of, cloud computing resources for which a future requirement is anticipated in accordance with an SLA.

The workloads layer 340 provides examples of functionality for which the cloud computing environment may be utilized. Examples of workloads and functions include but are not limited to mapping and navigation 341; software development and lifecycle management 342; virtual classroom education delivery 343; data analytics processing 344; transaction processing 345; and vehicle information processing 346.

The invention in at least one embodiment includes a method and a system for organizing information from multiple sources accessible through one interface, and in a further embodiment the production, display and distribution of information obtained from the system. In a further embodiment, the system updates the information to provide current information in response to a query, while in an alternative or further embodiment information is updated based on information type (or data category) on a predetermined schedule. In further embodiments, the system normalizes the information obtained from different sources to provide a common syntax in the system for processing the information. In at least one implementation, the method is provided through software as a service. In at least one implementation, the various described embodiments are assembled to form another embodiment.

The system in at least one embodiment includes a plurality of modules running on at least one processor and at least one database. The plurality of modules include but are not limited to a user interface module, at least one module associated with at least one data category, at least one external data source module, and a packet transmission module. In at least one embodiment, the at least one database includes a plurality of data tables and a file structure for storing documents associated with database entries.

Examples of data tables include but are not limited to company (470), store (or dealership) (472), and vehicle (460, 480). Examples of vehicles include but are not limited to cars, trucks, sport utility vehicles (SUV), motorcycles, recreational vehicles (RV), and other motored powered vehicles. Another example of a database structure is illustrated in FIG. 4D. The different data tables are associated to each other through relational keys (or foreign keys). For example, for a company that has multiple dealerships, each of the dealerships will be associated with the company through a relational key. Likewise, each vehicle in the system will be associated with a dealership through a relational key.

In at least one embodiment, the vehicle data table includes a primary table (e.g., 480) and a plurality of originating information tables (e.g., 460-466) where the primary table provides the information to be included in the packets. In an alternative embodiment, the vehicle data table includes the primary table a plurality of secondary tables with each secondary table being associated with a respective data category (or data source). The originating information table and/or secondary tables are associated with the primary table through relational keys (or foreign keys).

Examples of data categories include but are not limited to a vehicle description (with or without photographs); an inspection report; repair orders; a disclosure; a warranty; NADA; Kelley Blue Book; a vehicle history such as a report from CarFax or AutoCheck, a Experian company; a mechanical check; a maintenance record for the vehicle such as a vehicle master inquiry (VMI); a manufacturer suggested retail price; financing; and dealership information. The mix of data categories for any one company or store may vary from other companies or stores, and in a further embodiment the mix of data categories is different between an internal use at a company or store as compared to what is available to the public based on company or store preferences. In at least one embodiment, the mix of data categories can vary across vehicles based on settings and available information. In at least one embodiment, each of these data categories has one or more modules running on at least one processor receiving, retrieving, or collecting from sources outside of the system and/or based on information already present in the system. The information provided by the various data categories allows for a store's sales team to have ready access to the information through, for example, a tablet while talking with the potential customer and thus be able to provide a more complete story about the vehicle to the potential customer.

According to at least one embodiment using the above described system, the method includes a variety of steps from initial entry of the vehicle into the system through providing packets regarding particular vehicles in the system on request. When a dealership receives a vehicle as part of a new car delivery, a trade-in, or a wholesale purchase, the dealership enters the basic information regarding the vehicle into their dealership management system 225. That information is then sent to (or pulled by) the intake module on a predetermined schedule such as each day at 3 am or some other overnight time. The intake module receives basic information from the dealership management system 225 that includes at least a vehicle identification number, but may also include manufacturer, model, color, mileage, and price. The intake module assigns a unique vehicle identifier to each vehicle before (or as part of) loading the vehicle information into the vehicle table. As part of the record for the vehicle, a foreign key is included to associate the vehicle to the store. In at least one embodiment, the information received from dealership management system 225 is placed into a DMS data table by the intake module.

Also as part of the information coming from the dealership management system 225 (or in an alternative embodiment through a third party vendor of the dealership) to the intake module, there is information identifying which vehicle(s) have been sold and no longer in inventory at the dealership. The intake module (e.g., vehicle manager module 420 and/or packet manager module 412 in FIG. 4A) then in the record associated with the sold vehicle(s) in vehicle data table identifies that the vehicle has been sold. One example of how this is done is by setting a flag to that effect.

The other data modules in the system may operate in a variety of ways. In at least one embodiment, when a vehicle record is created, the intake module sends a notification to the other modules associated with the data categories available for that particular dealership or company that a new vehicle record has been created and that information is to be gathered. In another embodiment, the other modules operate on a predetermined schedule to review the vehicle records contained in the system for missing information and/or old information before obtaining that information for the companies or dealerships that provide the information associated with that module.

In at least one embodiment, the system includes a dashboard module (e.g., 430 in FIG. 4C) that provides information regarding a plurality of vehicles and packets. The dashboard module provides information to the user based on the user's dealership and rights permission. The dashboard module generates a list of packets that have been sent to potential customers including the sender 1702, the recipient 1704, identification of the vehicle 1706, the time sent 1710, and whether the packet has been reviewed 1712 as illustrated, for example, in FIGS. 17A and 17B. In a further embodiment, the time when the packet was reviewed 1712′. The dashboard module also generates a list of the current inventory that identifies which data categories are available for that vehicle as illustrated, for example, in FIG. 17C or the number of packets sent out to potential customers over the a predetermined time period such as the last six months separated into months as illustrated, for example, in FIG. 17D. Either of these vehicle lists may include information regarding the length of time in inventory 1726 allowing for a decision to be made about an adjustment to marketing strategy or price with the possibility of contacting again potential customers that have previously received a packet for this vehicle, for example, if the price is reduced.

In a further embodiment, the dashboard module provides a list of active vehicles or recently received vehicles that allows the user to select a particular vehicle for viewing the packet associated with that vehicle as illustrated, for example, FIG. 11B, viewing the list of recipients of packets for that vehicle as illustrated, for example, in FIG. 17E, preparing a PDF of the packet for that vehicle, or sending a packet for that vehicle to a potential customer as illustrated, for example, in FIG. 12B. The dashboard module in at least one embodiment allows for searching of the database for the dealership's vehicles as illustrated as 1701, for example, in FIG. 17A. In at least one further embodiment, the preparing a PDF and sending a packet allow for the user to select which data types are provided in the PDF or to the customer as illustrated, for example, in FIG. 12B. The listed available data types are based on the data types that information for that vehicle in the system.

FIGS. 4A-4C illustrate an example of a system providing the backend and the frontend to perform at least one method embodiment described in this disclosure. FIG. 4A is an example backend, FIG. 4B is an example of the structure present in each manager module illustrated in FIG. 4A, and FIG. 4C is an example frontend with the backend components. In at least one embodiment, the illustrated components in FIGS. 4A and 4B are combined in various combinations.

In at least one embodiment, the frontend components work in conjunction with their respective backend counterparts as illustrated, for example, in FIG. 4C to interact with the database of the system. In at least one further embodiment, the backend components are accessed when data is being added, deleted, modified, etc. in the database as will be explained in the discussion that follows. Examples of the interfaces that may be used by the frontend components are depicted in FIGS. 11B, 11C, 12B, and 17A-17F.

FIG. 4D illustrates a set of data tables present in an example database, and based on this disclosure it should be understood that some of the data tables may be omitted, combined together, or separated into multiple data tables. In an alternative embodiment, the company data table 470 and the store data table 472 are consolidated into one table as a particular implementation may not require a two layer structure, for example, as to what might occur with a real estate agency. FIG. 4D also illustrates example linkages between the data tables.

The company manager module 402 interacts with the company data table 470 based at least in part on input received from the company module 432. In at least one embodiment, the company data table 470 includes information regarding the company for inclusion into a packet originating from that company including, for example, written description about the company, a logo, and contact information.

The store manager module 404 interacts with the store data table 472 based at least in part on input received from the store module 434. In at least one embodiment, the store data table 472 includes information regarding the store for inclusion into a packet originating from that store including, for example, written description about the store, a logo, and contact information.

In at least one embodiment, one or both of the company data table 470 and the store data table 472 may include preferences as to what information is displayed to users and/or customers. In a further embodiment, one or both of these data tables include any preferences to the operation of modules. In an alternative embodiment, one or both of these data tables includes credentials for accessing third party information sources.

The user manager module 406 interacts with the user role data table 474, the role data table 476, the users data table 478, and the contact information data table 479 based at least in part on input received from the user module 436. In at least one embodiment, the user role data table 474 with the role data table 476 provides a definition of various roles or positions of the users identified in users data table 478 of the system. In at least one embodiment, the user role data table 474 and the role data table 476 are consolidated into one data table. The users data table 478 includes the identities of the users of the systems including linking them to a particular company present in the company data table 470. In at least one embodiment the users data table 478 and the contact information data table 479, which in at least one embodiment includes contact information for the users, are consolidated into one data table.

The data categories manager module 408 interacts with the packet data table 480, the system data categories file data table 490, the store data categories file data table 492, the store data categories data table 494, the data categories data table 496, the packet data categories data table 482, and the file pointers data table 498 as illustrated, for example, in FIG. 4D, which illustrates the relationships between these data tables in at least one embodiment. The packet data table 480 provides the base information for a particular vehicle that is displayed in the packet. In at least one embodiment, the data categories manager module 408 sets the data categories for a particular store in the store data categories data table 494, and this allows the mixture of data categories to vary between stores.

In at least one embodiment, the system contains three data category types which are vehicle, store, and system. A vehicle data category always contains a unique data set per vehicle. An example of this type of data category is a vehicle history report. Each packet that contains a vehicle history report will have a unique report specific to that vehicle. A store data category contains a data set that may be unique to a store but is applied to all vehicles in a specific group. For example, a system data category may contain information regarding extended warranties available which may apply to all vehicles or a subset filtered by make, model, model year and/or mileage. Once a store data category is defined and a vehicle enters the system that matches the criteria set by the data categories manager module 408 for this store data category, the store data category data set referenced in store data categories file data table 492 is applied to the vehicle packet by creating a reference in packet data categories data table 482. A system data category contains a data set that is common to all vehicles that match a specific criteria set in system data categories file table 490. For example, a Vehicle Manufacturer's Mechanical Checklist contains information that applies to all vehicles of a specific make. Once a system data category is defined and a vehicle enters the system that matches the criteria set by this system data category, the system data category data set referenced in system data categories field data table 490 is applied to the vehicle packet regardless of the vehicle's store by creating a reference in the packet data categories data table 482. The file pointers data table 498 identifies where in the file system files used by the system are stored.

The data categories manager module 408 also works with the packet manager module 412 to determine if there is data or other content present in the database, and when the content is a file they both together work with the file manager module 422 to retrieve the relevant file from the file system storage.

The photo manager module 410 works in the conjunction with the packet manager module 412 and the file pointers data table 498 to identify the photos (or other images) to be associated with a particular vehicle. In at least one embodiment, the photos are for that particular vehicle and/or stock photos of that manufacturer and model of vehicle. In at least one embodiment, a tools module 454 provides images that are uploaded through it by a user. In an alternative embodiment, there is a manager module for handling videos, audio files or other audiovisual material associated with a vehicle, a company, or a store. Or in another embodiment the video, audio or other audiovisual files are handled by the photo manager module 410. The photo manager module 410 works in part based on input received from, for example, the tools module 454.

The vehicle manager module 420 works in conjunction with the vehicle data table 460. The vehicle manager module 420 in at least one embodiment adds, deletes, archives, or annotates vehicles in the database and when a vehicle is added to a store inventory, the vehicle manager module 420 associates an unique vehicleID to the vehicle information, which in at least one embodiment reduces the potential for duplicate data because the VIN can be used to pull existing information about the vehicle from the database when the vehicle was previously entered into the system. An example of an annotation is by updating the vehicle data record to reflect that the vehicle has been sold. In a further embodiment, the vehicle manager module 420 links the vehicle data record in the vehicle data table 460 to the color data table 462, which is an optional data table; the model data table 464, which is an optional data table; and the manufacturer (or make) data table 466, which is an optional data table. Examples of how information for vehicle enters the system are the process flows relating to retrieving content and/or the vehicle inventory data stream illustrated in and discussed in connection with, for example, FIGS. 5A-10.

The file manager module 422 interacts, for example, with the dashboard module 430, the report module 431 and the tools module 454 and in part provides the primary interaction with the file pointers data table 498.

The packetshare manager module 414 responds to input received from, for example, the report module and/or the packet module 442 using, for example, the interface depicted in FIG. 12B. In at least one embodiment, the packetshare manager module 414 uses the method illustrated in FIG. 12A. The packetshare manager module 414 creates an entry in the packet_share data table 484 for each packet that is created for a recipient such as a potential customer or current customer. The packetshare manager module 414 in at least one embodiment assigns a version number to the packet to enable at a later date a determination to be made as to the information that was sent to the recipient along with when the information was viewed by the recipient. The packetshare manager module 414 uses the email manager module 418 to create and send the e-mail to the recipient. The email manager module 418 creates a data entry in the log email data table 486 for each e-mail that is sent from the system with a packet. The packetshare manager module 414 also works with the customer manager module 416 to confirm the contact information or to create a new customer (or recipient) record in the customer data table 488. In at least one embodiment as illustrated, for example, in FIG. 12A, the packetshare manager module 414 provides notifications to the user that sent the packet when the link and/or packet is viewed by the recipient, which depending on the implementation could be, for example, the first time, each time, or the next time after a predetermined time after the first time.

In at least one embodiment, each manager module contains the functional capabilities that allow the frontend to interact with the database and storage backend systems. An example of this is that the logic to create, update, delete, or retrieve data elements are performed by the manager modules. As illustrated in FIG. 4B, an example generic manager module includes a manager sub-module 424, a gateway sub-module 426, and a data access object (DAO) sub-module 428. The manager sub-module 424 interacts with the sub-modules illustrated as the gateway sub-module 426 and the data access object sub-module 428.

In at least one embodiment, the gateway sub-module 426 provides access to read and return data stored in the database and storage backend systems. Any calls to a particular manager sub-module 424 that require data to be returned to the frontend sub-module are sent to the gateway sub-module 426 to process the request, retrieve the data, and return it to the manager sub-module 424 where it can be formatted as needed and sent back to the frontend sub-module for presentation through, for example, a display.

In at least one embodiment, the data access object sub-module provides an interface between the frontend sub-module and the database and the storage system backend. Any calls to manipulate data (e.g., create, delete, update) are passed form the manager sub-module 424 to the data access object sub-module 428 for processing. In at least one embodiment, this acts as a security mechanism by hiding the database structure from the frontend sub-module. In a further embodiment, this structure allows for quicker sub-module development by allowing changes to the data functions to be confined to a specific area which are then passed to the frontend module through system calls.

FIG. 4C illustrates a variety of example frontend modules that interact with the above-described manager modules in a variety of ways. The below descriptions provide an example of how in at least one embodiment the frontend modules interact with the manager modules 402-422.

As mentioned previously and will be developed in more detail later, the dashboard module 430 interacts with all of the manager modules 402-422 to provide, in at least one embodiment, the primary interface to the user for interacting with the system and more particularly with the database. The dashboard module in at least one embodiment works in conjunction with the other frontend modules.

The report module 431 allows a user to access the status of a packet(s) and packet history along with other metrics relating to information in the database. In at least one embodiment, the level of access is controlled by a user role and level of permissions. As such, the report module 431 communicates with the data categories manager module 408, the packet manager module 412, the packetshare manager module 414, the customer manager module 416, the vehicle manager module 420, and the file manager module 422.

The company module 432 allows a user to view, add, modify, and delete company information and to associate users with the company. In at least one embodiment, the level of access is controlled by a user role and level of permissions. As such the company module 432 communicates with the company manager module 402 and the user manager module 406.

The store module 434 allows store information, store users, store data categories, and store data sources to be added, deleted, modified, etc. in the database by a user. In at least one embodiment, the level of access is controlled by a user role and level of permissions. The store module 434 communicates with the store manager module 404 and the user manager module 406.

The user module 436 allows a user to login into the system and maintain their respective password, contact information, and notification preferences. In at least one embodiment, the level of access is controlled by a user role and level of permissions. As such the user module 436 interacts with the company manager module 402, the store manager module 404, and the user manager module 406. In at least one embodiment, the user module 436 is the module through which the user authenticates himself/herself to the system. In an alternative embodiment, the authentication can vary between companies and/or stores and/or user roles.

The packet module 442 allows a user to send packets, print packets, view packet send history, view a packet(s), and view packet listings. In at least one embodiment, the level of access is controlled by a user role and level of permissions. The packet module 442 communicates with the data categories manager module 408 (e.g., identified selection of available data categories for a particular vehicle), the packet manager module 412, the packetshare manager module 414, the vehicle manager module 420, and the file manager module 422.

The customer module 446 allows a user to view, add, modify, and/or delete customer information in the database through the customer manager module 416. In at least one embodiment, the level of access is controlled by a user role and level of permissions.

The tools module 454 allows a user to work with a document queue, and upload files, import NADA. In at least one embodiment, the level of access is controlled by a user role and level of permissions. In at least one embodiment, there is a user with the permission level to work the system data categories with the data categories manager module 408. The tools module 454 communicates with the photo manager module 410, the packet manager module 412, the vehicle manager module 420, and the file manager module 422.

FIGS. 5A-5B illustrate an example method according to at least one embodiment for populating the system with information and data. Data about the vehicles may be collected from a multitude of sources including, for example but not limited to: the Dealership Management System, the vehicle manufacture's computer system(s) such as information relating to warranty and MSRP, third party data resources such as Carfax, Autocheck, NADA, Kelley Blue Book (KBB), and the dealership's website hosting provider. This data is encoded and stored in many different native formats including: images, PDF documents, text documents, XML data feeds, and relational databases. Depending on the selection of instructions embedded into particular code, the information can be programmatically retrieved on an hourly, daily, weekly or monthly basis depending on system implementation when it is believed refreshing the data periodically or even when data changes or requires updating. In some circumstances after the raw data has been collected it must be processed or filtered prior to inclusion into a packet for a particular vehicle.

The database is queried for active vehicles, 502. In a more particular embodiment, the vehicle data table in the database is queried. In a further embodiment, the querying of vehicles is done based on the store. In an alternative embodiment, this process is initiated when a vehicle is loaded into the system.

For each active vehicle located, the database is queried to determine if the system has images including photographs for the vehicle, 504. In at least one embodiment, the presence of an image(s) is indicated in a data table associated with the vehicle including a file location for the image(s). In an alternative embodiment, the determination is based on whether there is a file directory in the file system storage for images for that vehicle. In an alternative embodiment, the images further include video, animation or other audio-visual file. In a further embodiment to the alternative embodiment, when there are multiple types of audio-visual files possible, then each type is handled separate using a process described for the images.

When there is no image associated with the vehicle, the image is located if available, 506. Locating the vehicle image in at least one embodiment includes: querying the database to locate the source of the vehicle image(s) such as the dealership or a third party vendor or a stock image source, retrieving the vehicle image(s) from the source, processing the image(s) for size and type, storing the image in the structure file system present on the storage such as by having an image file directory associated with the vehicle, and inserting or updating a record in the appropriate data table identifying the location of the images in the file system (and in a further embodiment the date the image(s) was processed).

If there are images present in the system, then a determination is made as to whether there is a newer image(s), 508. One way to accomplish this determination is to compare the image(s) present in the system to the image(s) present at the source such as a web hosting provider for the dealership, and if there is a difference in the image based on, for example, the contents, the name, and/or the creation date, then a newer image(s) may be available when the source has a more recent image(s). The source of the image may be, for example, preset based on the dealership, the company, the vehicle manufacturer, or the vehicle. An example of a source based on the vehicle includes images uploaded directly into the system and stored in a file directory associated with the vehicle.

When a newer image(s) is available, retrieving the newer image(s), 510. In a further embodiment, retrieving includes processing the image(s) for size and type, storing the image in the structure file system present on the storage such as by having an image file directory associated with the vehicle, and inserting or updating a record in the appropriate data table identifying the location of the images in the file system (and in a further embodiment the date the image(s) was processed). In an alternative embodiment, the previous image(s) is archived or deleted from the system.

As illustrated in FIG. 5A, the database is queried to determine whether the vehicle is a Certified Pre-Owned (CPO) vehicle, 512. An example of how this determination is made is reviewing a data table associated with the vehicle to see if a flag has been set to the vehicle being a CPO vehicle or to see if the CPO data category is associated with the vehicle.

The database is queried to determine which data categories are relevant for a CPO vehicle and loading those data categories into a category array, 514. The system then performs iterative loops through the array to obtain and/or update data, 516.

When the vehicle is not a CPO vehicle, 512, or the iterative loop has completed going through the array for the CPO data categories, 518, then the database is queried to determine what system data categories are available for all of the dealerships in the system loading those data categories into an array (or second array), 518. The system then performs iterative loops through that array to obtain and/or update data, 520.

The database is queried to determine what store data categories are available for the dealership (or the company) associated with the vehicle loading those data categories into an array (or third array), 522. In at least one embodiment, these dealer specific data categories represent data categories that provide information for that particular dealership, which in at least one embodiment, there are dealerships in the system that may not use that data category. The system then performs iterative loops through that array to obtain and/or update data, 524.

The system in an alternative embodiment creates content based on the data in the database to be placed into predefined templates, 526. Examples of created content include one or more PDFs and one or more images (or videos).

The process for updating and/or obtaining information ends, 528.

FIG. 5B illustrates an example of an iterative process that may be used as part of the method illustrated in FIG. 5A or 5C. The system loops through the array by setting a counter to start at 1 and end with n where n is the number of the data categories in the array, 550. The system determines if the counter is greater than n, 552. When the counter exceeds n, the system then proceeds to the next step in FIG. 5A or FIG. 5C after the iterative loop step for which the method illustrated in FIG. 5B was used.

The system determines whether the database has content for the data category, 556. When there is no content for the data category associated with the vehicle, a retrieval application (or module) retrieves the content if available and updates the data record(s) for the vehicle, 558. In at least one embodiment, retrieving includes updating the content to match the newer content. In another embodiment, retrieving includes storing the content (for example, if it is a document or a file) in the (structure) file system present on the storage such as by having a file directory associated with the vehicle, and inserting or updating a record in the database identifying the location of the images in the file system (and in a further embodiment the date the image(s) was processed). In at least one embodiment, there is a mixture of the above embodiments for retrieving depending upon the data category.

When there is content present, the retrieval application determines whether newer content is available for that data category, 560. When the content is not newer, than the method proceeds to step 564. When there is newer content available, the retrieval application retrieves the newer content for that data category and updates the data record(s) for the vehicle, 562. In at least one embodiment, retrieving includes updating the content to match the newer content. In another embodiment, retrieving includes storing the content (for example, if the content is a document or a file) in the (structure) file system present on the storage such as by having a file directory associated with the vehicle, and inserting or updating a record in the database identifying the location of the images in the file system (and in a further embodiment the date the image(s) was processed). In a further embodiment, the previous content is archived or deleted from the system. In at least one embodiment, there is a mixture of the above embodiments for retrieving depending upon the data category.

The retrieve application advances the counter by 1 and goes back to step 552.

FIG. 5C is similar to FIG. 5A and shares steps 502, 516, 526, and 528 with FIG. 5A. After a search of the database for active vehicles by store, 502, is performed, then the data categories for the vehicle are loaded into a category array based on a set of factors, 514′. In at least one embodiment, the factors include what data categories are applicable to all stores in the system, what data categories the store has for its vehicles, what data categories are available for the vehicle. In a further embodiment, the vehicle data categories are those that are designated by the store. In another embodiment, the vehicle data categories are selected based on some combination of whether the car is new or used, if used whether it is a certified pre-owned vehicle, manufacturer (or make), the model, and the year. In at least one embodiment, the previous two embodiments are combined.

FIGS. 6A-6E illustrate an example method according to at least one embodiment for populating the system with information and data. As discussed above, data about the vehicles may be collected from a multitude of sources and be in a variety of formats. FIGS. 6A-6E provides a flowchart relating to a data collection aspect of at least one embodiment according to the invention. Depending on the selection of instructions embedded into particular code, the information can be programmatically retrieved on an hourly, daily, weekly or monthly basis depending on system implementation when it is believed refreshing the data periodically or even when data changes or requires updating. In some circumstances after the raw data has been collected it must be processed or filtered prior to inclusion into a packet for a particular vehicle.

The database is queried for active vehicles, 602. In a more particular embodiment, the vehicle data table in the database is queried. In a further embodiment, the querying of vehicles is done by store. In an alternative embodiment, this process is initiated when a vehicle is loaded into the system.

For each active vehicle located, the database is queried to determine if the system has images including photographs for the vehicle, 604. In at least one embodiment, the presence of an image(s) is indicated in a data table associated with the vehicle including a file location for the image(s). In an alternative embodiment, the determination is based on whether there is a file directory in the storage for images for that vehicle. In an alternative embodiment, the images further include video, animation or other audio-visual file. In a further embodiment to the alternative embodiment, when there are multiple types of audio-visual files possible, then each type is handled separate using a process described for the images.

If there are images present in the system, then a determination is made as to whether there is a newer image(s), 606. One way to accomplish this determination is to compare the image(s) present in the system to the image(s) present at the source such as a web hosting provider for the dealership, and if there is a difference in the image based on, for example, the contents, the name, and/or the creation date, then a newer image(s) is available if the source is more recent. The source of the image may be, for example, preset based on the dealership, the company, the vehicle manufacturer, or the vehicle. An example of a source based on the vehicle includes images uploaded directly into the system and stored in a file directory associated with the vehicle.

When a newer image(s) is available, retrieving the newer image(s), 608. In a further embodiment, retrieving includes processing the image(s) for size and type, storing the image in the structure file system present on the storage such as by having an image file directory associated with the vehicle, and inserting or updating a record in the database identifying the location of the images in the file system (and in a further embodiment the date the image(s) was processed). In an alternative embodiment, the previous image(s) is archived or deleted from the system.

When there is no image associated with the vehicle, the image is located if available, 610. Locating the vehicle image in at least one embodiment includes: querying the database to locate the source of the vehicle image(s), retrieving the vehicle image(s) from the source, processing the image(s) for size and type, storing the image in the structure file system present on the storage such as by having an image file directory associated with the vehicle, and inserting or updating a record in the database identifying the location of the images in the file system (and in a further embodiment the date the image(s) was processed).

As illustrated in FIG. 6A, the database is queried to determine whether the vehicle is a Certified Pre-Owned (CPO) vehicle, 612. An example of how this determination is made is reviewing a data table associated with the vehicle to see if a flag has been set to the vehicle being a CPO vehicle or to see if the CPO data category is associated with the vehicle.

The database is queried to determine which data categories are relevant for a CPO vehicle and loading those data categories into an array, 614. The system then loops through the array starting at 1 and ending with n where n is the number of the last data category in the array, 616. The system determines if there is another data category to be processed, 618. When there is another data category to be processed, the system uses a retrieval application running on the at least one processor to query the data table for that data category to determine whether there is content present in the system for that vehicle in that data category, 620. In at least one embodiment, the retrieval application is for that particular data category. When there is content present, the retrieval application determines whether newer content is available for that data category, 622 (FIG. 6B).

When there is newer content available, the retrieval application retrieves the newer content for that data category, 624 (FIG. 6B). In at least one embodiment, retrieving includes updating the content to match the newer content. In another embodiment, retrieving includes storing the content (for example, if it is a document or a file) in the structure file system present on the storage such as by having a file directory associated with the vehicle, and inserting or updating a record in the database identifying the location of the content in the file system (and in a further embodiment the date the content was processed). In a further embodiment, the previous content is archived or deleted from the system. In at least one embodiment, there is a mixture of the above embodiments for retrieving depending upon the data category.

When there is no content for the data category associated with the vehicle, the retrieval application retrieves the content if available, 626. In at least one embodiment, retrieving includes updating the content to match the newer content. In another embodiment, retrieving includes storing the content (for example, if it is a document or a file) in the structure file system present on the storage such as by having a file directory associated with the vehicle, and inserting or updating a record in the database identifying the location of the content in the file system (and in a further embodiment the date the content was processed). In at least one embodiment, there is a mixture of the above embodiments for retrieving depending upon the data category.

After steps 624 or 626, the method returns to step 616. When it is determined there is no newer content in step 622, the method returns to step 616.

When the vehicle is not a CPO vehicle, 612, or the loop has completed going through the array for the CPO data categories, 618, then the database is queried to determine what basic data categories are available for all of the dealerships in the system loading those data categories into an array (or second array), 628 (FIG. 6C). In at least one embodiment, the basic data categories represent data categories that provide information in a predefined presentation format such as PDF. The system then loops through the array starting at 1 and ending with n where n is the number of the last data category in the array, 630. The system determines if there is another data category to be processed, 632. When there is another data category to be processed, the system uses a retrieval application running on the at least one processor to query the data table for that data category to determine whether there is content present in the system for that vehicle in that data category, 634. In at least one embodiment, the retrieval application is for that particular data category. When there is content present, the retrieval application determines whether newer content is available for that data category, 636.

When there is newer content available, the retrieval application retrieves the newer content for that data category, 638. In at least one embodiment, retrieving includes updating the content to match the newer content. In another embodiment, retrieving includes storing the content (for example, if it is a document or a file) in the structure file system present on the storage such as by having a file directory associated with the vehicle, and inserting or updating a record in the database identifying the location of the content in the file system (and in a further embodiment the date the content was processed). In a further embodiment, the previous content is archived or deleted from the system. In at least one embodiment, there is a mixture of the above embodiments for retrieving depending upon the data category.

When there is no content for the data category associated with the vehicle, the retrieval application retrieves the content if available, 640. In at least one embodiment, retrieving includes obtaining the content. In another embodiment, retrieving includes storing the content (for example, if it is a document or a file) in the structure file system present on the storage such as by having a file directory associated with the vehicle, and inserting or updating a record in the database identifying the location of the content in the file system (and in a further embodiment the date the content was processed). In at least one embodiment, there is a mixture of the above embodiments for retrieving depending upon the data category.

After steps 638 or 640, the method returns to step 630. When it is determined there is no newer content in step 636, the method returns to step 630.

When the loop has completed going through the array for the basic data categories, 632, then the database is queried to determine what basic data categories are available for the store (or the company) associated with the vehicle loading those data categories into an array (or third array), 642 (FIG. 6D). In at least one embodiment, these store specific data categories represent data categories that provide information for that particular dealership, which in at least one embodiment, there are dealerships in the system that may not use that data category. The system then loops through the array starting at 1 and ending with n where n is the number of the last data category in the array, 644. The system determines if there is another data category to be processed, 646. When there is another data category to be processed, the system uses a retrieval application running on the at least one processor to query the data table for that data category to determine whether there is content present in the system for that vehicle in that data category, 648. In at least one embodiment, the retrieval application is for that particular data category. When there is content present, the retrieval application determines whether newer content is available for that data category, 650.

When there is newer content available, the retrieval application retrieves the newer content for that data category, 652. In at least one embodiment, retrieving includes updating the content to match the newer content. In another embodiment, retrieving includes storing the content (for example, if it is a document or a file) in the structure file system present on the storage such as by having a file directory associated with the vehicle, and inserting or updating a record in the database identifying the location of the content in the file system (and in a further embodiment the date the content was processed). In a further embodiment, the previous content is archived or deleted from the system. In at least one embodiment, there is a mixture of the above embodiments for retrieving depending upon the data category.

When there is no content for the data category associated with the vehicle, the retrieval application retrieves the content if available, 654. In at least one embodiment, retrieving includes obtaining the content. In another embodiment, retrieving includes storing the content (for example, if it is a document or a file) in the structure file system present on the storage such as by having a file directory associated with the vehicle, and inserting or updating a record in the database identifying the location of the content in the file system (and in a further embodiment the date the content was processed). In at least one embodiment, there is a mixture of the above embodiments for retrieving depending upon the data category.

After steps 652 or 654, the method returns to step 644. When it is determined there is no newer content in step 650, the method returns to step 644.

When the loop has completed going through the array for the dealership data categories, 642, then the database is queried to determine what complex data categories are available for the dealership loading those data categories into an array (or fourth array), 656 (FIG. 6E). In at least one embodiment, the complex data categories represent data categories that provide information that needs to be reformatted or to be reformatted to fit within a template to present the information in a predefined presentation format such as PDF. The system then loops through the array starting at 1 and ending with n where n is the number of the last data category in the array, 658. The system determines if there is another data category to be processed, 660. When there is another data category to be processed, the system uses a retrieval application running on the at least one processor to query the data table for that data category to determine whether there is content present in the system for that vehicle in that data category, 662. In at least one embodiment, the retrieval application is for that particular data category. When there is content present, the retrieval application determines whether newer content is available for that data category, 664.

When there is newer content available, the retrieval application retrieves the newer content for that data category, 666. In at least one embodiment, retrieving includes updating the content to match the newer content. In another embodiment, retrieving includes storing the content (for example, if it is a document or a file) in the structure file system present on the storage such as by having a file directory associated with the vehicle, and inserting or updating a record in the database identifying the location of the content in the file system (and in a further embodiment the date the content was processed). In a further embodiment, the previous content is archived or deleted from the system. In at least one embodiment, there is a mixture of the above embodiments for retrieving depending upon the data category.

When there is no content for the data category associated with the vehicle, the retrieval application retrieves the content if available, 668. In at least one embodiment, retrieving includes obtaining the content. In another embodiment, retrieving includes storing the content (for example, if it is a document or a file) in the structure file system present on the storage such as by having a file directory associated with the vehicle, and inserting or updating a record in the database identifying the location of the content in the file system (and in a further embodiment the date the content was processed). In at least one embodiment, there is a mixture of the above embodiments for retrieving depending upon the data category.

After steps 666 or 668 or a no for step 664, the system retrieves stored content from the database for that data category for that vehicle to create a presentation file such as a PDF document, HTML file, or an image file of the content using pre-defined templates before returning to step 658.

When the loop has completed going through the array for the basic data categories, 660, then the process is completed, 672, for that vehicle and the next vehicle, if any, is processed using this method.

In an alternative embodiment, two or more of the CPO, basic, dealership specific, and complex data categories are combined into one iterative process for the vehicle.

In an another alternative embodiment, a particular retrieval application operates independent of this process and performs the steps for each vehicle that does not have the information associated with the retrieval application in its respective data table(s). In at least one embodiment, the retrieval application will operate on a predetermined schedule such as hourly, daily, each business day, weekly, monthly, bi-monthly, quarterly, etc. The particular retrieval application retrieves the content if available from a predetermined data source. The predetermined data source may be defined in the retrieval application, by the company, by the dealership, by the manufacture, another source, or a combination of any of these sources. In at least one embodiment, retrieving includes adding or updating the content to match the newer content. In another embodiment, retrieving includes storing the content (for example, if it is a document or a file) in the structure file system present on the storage such as by having a file directory associated with the vehicle, and inserting or updating a record in the database identifying the location of the content in the file system (and in a further embodiment the date the content was processed).

In at least one embodiment, the content retrieved by the system includes files for storing in the file system and/or data for storing in the database.

Examples of data categories for which a retrieval application may operate independent include an automobile history report (e.g., CarFax of AutoCheck) or a NADA report. FIG. 7 illustrates an example of a method that might be performed by an automobile history report retrieval application. The retrieval application searches the database for all active vehicles without a vehicle history report, 702. In at least one embodiment, the search is limited by age, manufacture, or other characteristic of the vehicle based on the coverage of the file history source. In at least one embodiment, any vehicle with a flag indicating previous failures to retrieve the vehicle history report is omitted from the search results where the flag is provided by optional steps 716-720. In another embodiment, any vehicle being sold by a dealership that does not provide the type of vehicle history report is excluded from the search, for example, by a flag or other notation in a data table associated with the vehicle, which includes identification of the possible data categories for the vehicle.

For each vehicle identified by the search, determine which dealership the vehicle is associated with (i.e., being sold by to the public), 704. Obtain the credentials from the dealership for the source of the vehicle history report, 706. In at least one embodiment, the source will be predetermined. An example of how the credentials are obtained is by retrieving them from the dealership data table (e.g., store data table 472) in the system.

The retrieval application retrieves the vehicle history report from the source using the dealership's credentials, 708. A determination is made whether the vehicle history report exists, 710. If the report exists, then the vehicle history report is loaded into the system, 712. The loading includes converting the document to PDF or other presentation format, storing the content (for example, if it is a document or a file) in the structure file system present on the storage such as by having a file directory associated with the vehicle, and inserting or updating a record in the database identifying the location of the report in the file system (and in a further embodiment the date the report was processed). In an alternative embodiment, the converting step is omitted. The retrieval application then proceeds to the next located vehicle, 714.

FIG. 7 also illustrates an optional flag and/or notification embodiment for when the vehicle history report does not exist. A counter for failed attempts for this vehicle history report for this vehicle is incremented by 1, 714. If the counter exceeds a predetermined threshold, 716, a notification is sent to a predetermined entity (e.g., the dealership, review staff, or support personnel) that there may be a problem as no vehicle history report is available and/or set a flag that the vehicle history report for this vehicle should be skipped, 718. If the counter does not exceed the threshold, then the method returns to the dealership determination step. In an alternative embodiment, if no vehicle history report exists, then step 718 occurs or alternatively step 704 occurs. The notification can provide an indication if there is widespread issues, because possibly there has been a change in the interface with the vehicle history report source. In an alternate embodiment, instead of using a flag to remove vehicles, the number on the counter is used in conjunction with the predetermined threshold. In a further embodiment, different runs of the retrieval application may use different predetermined thresholds.

In alternative embodiment, the retrieval application retrieves a new vehicle history report after a predetermined time after the prior vehicle history report was pulled to provide potentially updated information. In this alternative embodiment, the search in 702 becomes a search for active vehicles without a vehicle history report dated in the last predetermined time.

FIG. 8 illustrates another example retrieval application that pulls repair orders or a vehicle maintenance record such as a vehicle master inquiry from a Mercedes Benz dealership management system. The retrieval application searches the database for all active vehicles without a maintenance record report, 802. In at least one embodiment, any vehicle being sold by a dealership that does not provide this data category of the retrieval application is excluded from the search, for example, by a flag or other notation in a data table associated with the vehicle, which includes identification of the possible data categories for the vehicle.

For each vehicle identified by the search, determine which dealership the vehicle is associated with (i.e., being sold by to the public), 804. Communicate with the dealership management system (DMS) for that particular dealership, 806.

If there is no information available in the DMS, then the retrieval application moves to the next located vehicle, 808, 816. Otherwise, a determination is made whether the database record for the vehicle in the system contains any information, 810. If it does not then, the information is retrieved from the DMS, 818 before proceeding to the next vehicle, 816. Otherwise, a determination is made whether the information in the DMS is updated version of the information over what is contained in the database of the system, 812. One example way to make this determination is a comparison between the upload date for the information into the database compared to the last modification date of the record in the DMS for the vehicle. If the information is update, then the retrieval application proceeds to the next vehicle, 816. Otherwise, the updated information is retrieved, 814.

In at least one embodiment, retrieving includes pulling the information from the DMS, scrubbing any personal identifying information such as names and contact information for prior owners, converting the document to PDF or other presentation format, storing the content (for example, if it is a document or a file) in the structure file system present on the storage such as by having a file directory associated with the vehicle, and inserting or updating a record in the database identifying the location of the images in the file system (and in a further embodiment the date the image(s) was processed). In an alternative embodiment, the converting step is omitted.

In alternative embodiment, the retrieval application includes a filter for vehicles that do not have the information being retrieved and/or information that was last updated longer than a predetermined time.

FIG. 9 illustrates another example retrieval application for obtaining MSRP information for the vehicle. Based on this figure, it should be understood that other vehicle characteristics that do not change over time could likewise benefit from an internal review of the database in the system before checking external sources such as the manufacturer. The retrieval application begins with a search of the database for active vehicles that do not have any MSRP information associated with them, 902. For each located vehicle, the database is then searched for the VIN to see if the vehicle was previously entered into the database, 904, and whether that prior entry includes MSRP information. When a match is found, 908, the vehicle is linked to the data records associate with the matching VIN, which includes the MSRP information, 910. When no match is found, 908, the information is retrieved from an external source such as the manufacturer, 912. The method is repeated for the next located vehicle, 914, until there are no more located vehicles left. In an alternative embodiment, the MSRP information is not searched for if the vehicle falls outside a predefined years in which that information is available.

In an alternative embodiment, any located vehicle records with a matching VIN are associated together to create a system based vehicle history report.

In at least one embodiment, there is at least one retrieval application that pulls data from multiple sources to provide information to a packet. An example of this is the rate data category that pulls financing terms for a CPO vehicle from the manufacture and adds a spread to the manufacturer financing terms to reflect the adjustment by a particular dealership. This allows for individual dealerships to use a common rate table for the manufacture while providing for a level of profit from any loans that are issued for the CPO vehicle without the need to track or adjust financing terms as they change over time. In an alternative embodiment, the finance rates are set as discussed in connection with FIG. 17F.

Examples of the types of data categories that may be present in the system are as follows with an identification of whether the data category is system, store, or vehicle based, name, description, and applicable to new and/or used vehicles. The MechCheck is an example of a hybrid data category where in at least one embodiment, a check is performed to determine whether there is a completed mechanical check on file for a particular vehicle, which is then displayed if available, otherwise in at least one embodiment a blank mechanical checklist form for the vehicle is displayed as a sample to show what the dealership checks on the vehicle prior to selling it as a used vehicle.

| | | | Vehicle |
|---|---|---|---|
| Type | Name | Description | Type |
| Vehicle | Description | Description | Both |
| Vehicle | CarFax | CarFax History | Used |
| | | Report | |
| Vehicle/ | MechCheck | Certified Mechanical | Used |
| System | | Inspection | |
| Vehicle | RO | Repair Receipts | Used |
| Vehicle | VMI | Vehicle In-Service | Used |
| | | Date/Warranty History | |
| Vehicle | Disclosure | Previous Owner | Used |
| | | Disclosure | |
| Vehicle | MSRP | MSRP | Both |
| System | Warranty | Certified Pre-Owned | Used |
| | | Warranty Review | |
| Store | Rate | Available Financing | Both |
| | | Option | |
| Vehicle | Value | Retail Value Report | Used |
| System | Inspection | Certified Pre-Owned | Used |
| | | Inspection | |
| Vehicle | AutoCheck | AutoCheck History | Used |
| | | Report | |
| Vehicle | Invoice | Invoice | Both |
| System | Warranty | New Warranty | New |
| System | Brochure | Vehicle Brochure | New |
| Vehicle | PDI | Pre-Delivery | New |
| | | Inspection | |
| Vehicle | DevReceipt | Delievery Receipt | New |
| Store | AboutUs | About Us | Both |
| System | Roadside | Roadside Assistance | Both |
| System | xWarranty | Extended Warranty | Both |
| Vehicle | Images | Vehicle Images | Both |
| Vehicle | Video | Vehicle Video | Both |
| Vehicle | KarPower | Kar Power | Used |
| Vehicle | DT_NADA | NADA Vehicle Values | Used |
| | | from DealerTrack | |
| Store | Promise | Dealer Promise | Both |
| System | AutoButler | Auto Butler | Both |
| Vehicle | Title | Vehicle Title | Both |
| Vehicle | Equipment | vAuto Vehicle | Used |
| | | Equipment Sheet | |
| Vehicle | BuyersGuide | Buyers Guide | Used |
| Vehicle | MPG | MPG | Both |
| Vehicle | NadaValue | NADA values from | Used |
| | | NADA Configurator | |
| Vehicle | Sticker | Original Window | Both |
| | | Sticker (MSRP) | |
| Vehicle | KBBValue | Kelley Blue Book | Used |

In at least one embodiment, the vehicle based data categories are selected based on the store preferences. In a further embodiment, the contents of the system data categories is based on criteria for the store and/or vehicle such as the manufacturer, model year, model, etc.

In at least one embodiment, the system and store data categories pull information from a common data table such as based on the vehicle manufacturer or store specific information that might be provided as part of an AboutUs section in a packet.

FIG. 10 illustrates a method for data normalization according to at least one embodiment of the invention. The illustrated method is an example of how the different retrieval applications may normalize data from external sources to fit the data structure of the database and its accompanying data tables. Since the raw data is collected from different sources in potentially different forms and possessing different coding depending on the source, it must be processed in order to normalize the data and organize the various data sources so that the data can be stored with a common key to associate all data to a particular vehicle (e.g., vehicleID). Each data source may use a different unique vehicle identifier in their data feed. In at least one embodiment, relationships are established between each of these different unique identifiers in order to aggregate all the necessary information about a particular vehicle. There are also cases of multiple sources providing the same or similar data, but categorizing this data using different naming schemes. In such cases, the system must analyze and normalize the data in order to achieve a uniform scheme.

For example, where one data source refers to a vehicle type as a “car” while another data source refers to this same vehicle as a “sedan”, these variations are accounted for by the system in at least one embodiment. The system, accordingly, analyzes both data sources and alters one or both data sources in order to create a unified data structure. Another example is how the dealership management systems categorize a vehicles inventory status. One system may label a vehicle as “available” while another system may label a vehicle as “inventory”. Clearly both dealership management systems are indicating the vehicle is not sold, but label a vehicle status using different terminology requiring programming code in order to create a uniform labeling system.

An example of how data normalization may occur is illustrated in FIG. 10. The system retrieves (or receives) an inventory data feed from an external source, 1002. Each vehicle present in the inventory data feed is reviewed individually, 1004, 1020. A determination is made regarding whether the data formats are equal, 1006. When the data formats are not equal, the system translates the data based upon a set of predetermined rules, 1008, which in at least one embodiment are particular to that data feed format or source. Then a search of the database is performed for the vehicle using, for example, dealership identifier, a stock number, and/or a VIN to determine whether the vehicle is present in the database, 1010. When the vehicle is present in the database, a determination is made whether the data values are equal between the inventory data feed and the information present in the database, 1012. When the data is equal, then the information is current, 1014 (which step may be omitted), leading to reviewing the next vehicle in the inventory data feed, 1020, 1004.

If the vehicle is not present, 1010, then a new system vehicleID is assigned to the vehicle and a data record is created in the database to contain information from the inventory data feed, 1016. Then the next vehicle in the inventory data feed is considered, 1020, 1004.

When the data values are not equal, 1012, then the system decides which data is to be used, 1018. In at least one embodiment, the most current information is used based upon date creation/modified information associated with the information being compared. In another embodiment, the information from the inventory data feed is placed into a data table for another module to make the determination of which data to use based upon preferences that have been established in the system for which sources are to be the primary source, secondary source, third source, etc. until there is a source with the information for the data field. Although three sources are identified in this example, it should be understood that some data fields may only have one source, two sources, etc. An alternative preference approach is whether the closest 2 out of 3 will be used instead of the third source. The preferences may be set at the system level, the company level, the store level, the manufacturer level, etc. with different groupings having different preferences. The module then will use the preferences to make the determination.

FIG. 11A illustrates a method for displaying information regarding a vehicle. The system receives a request from a user for vehicle information, 1102, where the information request includes stock identifier, a VIN, a manufacturer, a model, or other search criteria. The system then determines whether the request includes a single vehicle identifier or multiple vehicle identifiers, 1104. If there is a single identifier, then a single query with the specific vehicle identifier is submitted, 1106. If there are multiple identifiers, then multiple queries are submitted to the database using all of the identifiers and joining together the query results, 1108. In an alternative embodiment, the system allows for Boolean searching to be used to create the query results to steps 1104-1108.

The query results are examined to see if more than one vehicle record was returned, 1110. If there were multiple vehicle records returned, the system displays an inventory page matching the search criteria, 1112. An example of such a page is depicted in FIG. 11B. In a further embodiment, the vehicle records displayed are ones that the user has rights to access. The system receives a vehicle selection from the user where the vehicle is included on the displayed inventory page, 1114.

When one record is returned or a vehicle selection is received from the user, the system determines which data categories are available for the vehicle, 1116. In a further embodiment, the system also determines which data categories are available to be displayed to the user. In a further embodiment, the available vehicles are based on the company, the store, the user, the user role, the access rights, or any combination of these. The system establishes a loop through the data categories that are available, 1118. One example of how to accomplish this is by use of a counter running from 1 to n where n equals the number of available data categories and the counter is used by the system to track its progress through each of the available data categories.

The system retrieves information for each of the available data categories being used on this loop, 1120. The system provides the retrieved information including, for example, a tab, a button, or a link to be selected for displaying the information through the display interface module, 1122. An example of such an interface is depicted, for example, in FIG. 11C. The loop proceeds to the next data category until there are no more data categories available for that particular vehicle.

In a further embodiment, the display interface module includes identification of the dealership and contact information for it. In another embodiment, the display interface module includes functionality to send the packet to a recipient and/or to print the packet as a PDF file (or alternatively another file format). In another embodiment, the user is able to see where the packet has been sent using the sent history functionality of the system based on information in, for example, the packet_share data table 484 and/or the log email data table 486. An example of this is depicted, for example, in FIG. 17E. In another embodiment, these embodiments are combined in a variety of different ways.

FIG. 11B also illustrates the interface including a checkbox (or selection box) for each of the displayed vehicles that can be used to select a plurality of vehicles for creation of a packet set to be sent to a recipient as discussed in connection with FIG. 12A. FIG. 11B also illustrates an alternative embodiment where there are predefined searches based on, for example, type, make, model, and certified.

FIG. 11C illustrates an example of a vehicle record being presented through the display interface module. “Modules” as used in the interface references data categories. FIG. 11C also illustrates that this particular vehicle includes a plurality of images that may be selected by the selection of a box from the plurality of boxes proximate the bottom of the displayed image. In an alternative embodiment, the images are rotated through automatically, for example, like a slide show.

FIG. 12A illustrates an example of a method for providing a packet to a recipient. Depending on when the decision is made by the user to send a packet to a recipient, steps 1202-1206 may be omitted or performed as part of, for example, the method illustrated in FIG. 11A. The packet module or packet share module receives selection of at least one vehicle from a system user from an inventory listing, 1202. The packet share module queries the database using, for example, the vehicleID(s) to retrieve available data categories for the vehicle(s), 1204. The packet share module loads the query results into an array for the vehicle(s), 1206. The packet share module displays a form to the system user, 1208. An example of such a form is illustrated in FIG. 12B.

The packet share module validates the received recipient's contact information, 1210, against a customer data table. If the contact information is not matched, then the user is provided the opportunity to create a new contact record for the recipient in conjunction with the customer module, 1212.

The packet share module collects the cartegoryID(s) for each category selected by the user and stores them into a new category list array, 1214. The packet share module loops over the array starting at index 1 and ending with index n where n is the array length, 1216. The packet share module performs a query using the vehicleID and the categoryID for each loop iteration to determine the location of content in the database or the file system, 1218. The packet share module retrieves content from the system for all categories selected to create at least one vehicle packet, 1220. In an optional embodiment, the packet share module creates an instance for the packet in the packet_share data table 484 that includes a unique URL for each packet_share instance, 1222. The packet share module in conjunction with the email module sends the URL (or other link) for the vehicle packet(s) to the recipient, 1224.

FIG. 12A also illustrates an alternative embodiment that provides information back to the sender when the packet is reviewed. The packetshare manager module 414 detects when the URL is accessed, it notifies the sender (system user) about the access, 1226. The packetshare manager module 414 looks up the sender's contact information and preferred notification preferences, 1228. The notification may be sent, for example, through e-mail, 1230, text, 1232, instant message (not illustrated), or a combination of any of these (e.g., 1230, 1232). In an alternative embodiment, the notification is sent for the first access of the URL. In an alternative embodiment, a PDF document (or other presentation format) is sent to the potential customer.

In at least one embodiment, the system includes a lead generation module that prepares a vehicle packet in response to receiving an electronic submission from an external system that originates with a potential customer. FIG. 13 illustrates an example method for the system to respond to an electronic submission. Auto dealership websites sometimes include functionality that allows for a perspective customer to submit an inquiry for additional information about a vehicle. The system in this embodiment may receive such electronic generated information request from the vehicle dealership website, which in at least one embodiment is formatted as an ADF XML document. The lead generation module then reviews the request for identifying information of the potential customer such as contact information including an e-mail address and the vehicle(s) that the potential customer is interested in receiving information. Based on the vehicle identification(s), the lead generation module performs a search of the database for the matching vehicle(s), 1302. The lead generation module then creates a packet for the vehicle(s) that includes available information, 1304. The lead generation module electronically sends the packet through the transmission module (e.g., the email manager module 418) to the e-mail address(es) of the potential customer, 1306. In at least one embodiment, the packet is sent in a format viewable across multiple computer, tablet, and telephone platforms or as a link to the information contained in the packet to display the information similar to FIG. 11C. In at least one embodiment, the information included in the packet is limited to the information contained in the system for that vehicle filtered by the data types selected by the dealership to be provided to these inquiries. The limitation on the data types can vary for different dealerships and companies based on predetermined selections.

In an optional embodiment, the system sends a notification to the store (or a designated individual at the store) that a packet for a vehicle for sale at the store has been sent to a potential customer, 1308.

Further in this embodiment, the packetshare manager module 414 creates an instance for the packet in the packet_share data table 484 that includes a unique URL for each packet_share instance, 1310.

FIG. 13 also illustrates an alternative embodiment that provides information back to the store when the packet is viewed. The packetshare manager module 414 detects the URL being accessed, it notifies the store about the access, 1312. The packetshare manager module 414 looks up the store's contact information for such notifications and preferred notification preferences, 1314. The notification may be sent, for example, through e-mail, 1316, text, 1318, instant message (not illustrated), or a combination of any of these (e.g., 1316, 1318).

In a further embodiment to the previous embodiment, the lead generation module checks the potential customer against a blacklist and/or a do not contact list to confirm that the requesting potential customer has not previously requested to not be contacted or alternatively has not be barred from receiving information from the system because of, for example, the potential customer is a competing dealership or has requested to many packets (i.e., the number of packets exceeds a predetermined threshold over a predetermined time period). These lists may be company or store specific.

In at least one embodiment, the lead generation module is part of the packetshare manager module 414.

FIGS. 14A-14B illustrate an alternative embodiment for a method for when an external source requests at least one packet. The packet module or packet share module receives selection of at least one vehicle from the external source, 1402. The external source requesting the packet on behalf of the end recipient is validated, 1404. In an alternative embodiment, this step and the associated step is omitted. If the external source is not validated, then a return message is sent to the external source indicating that it is not authorized to access the system, 1406. If the external source is validated, then it is determined whether a VIN or vehicleID is being provided, 1408. If a vehicleID is received, then a check is performed to see if it is connected to an active vehicle for sale, 1412. If a VIN is detected, then a determination is made whether the VIN is associated with an active vehicle for sale, 1410. If either the VIN or vehicleID are not associated with an active vehicle for sale, then a return message is sent to the external source indicating that an active vehicle was not found, 1414. If the VIN is for an active vehicle, then the vehicleID is obtained, 1416. The system uses the vehicleID for an active vehicle to query the database for the information associated with the active vehicle. In an alternative embodiment, the VIN is used to locate the vehicle in the system. In an alternative embodiment, search criteria is received from the external source, and the search criteria is used to perform a search similar to that illustrated, for example, in FIG. 11A.

The customer manager module validates the received recipient's contact information, 1420, against a customer data table. If the contact information is not matched, then the system creates a new contact record for the recipient in conjunction with the customer module, 1422.

The method continues onto FIG. 14B where the packetshare manager module collects the cartegoryID(s) for each category selected by the external source and stores them into a new category list array, 1424. The packetshare manager module loops over the array starting at index 1 and ending with index n where n is the array length, 1426. The packetshare manager module performs a query using the vehicleID and the categoryID for each loop iteration to determine the location of content in the database or file system, 1428. The packetshare manager module retrieves content from the system for all categories selected to create at least one vehicle packet, 1430. The packetshare manager module 414 creates an instance for the packet in the packet_share data table 484 that includes a unique URL for each packet_share instance, 1432. The packetshare manager module 414 in conjunction with the email manager module 418 sends the URL (or other link) for the vehicle packet(s) to the recipient, 1434.

FIG. 14B illustrates an optional step of sending a notification to the store (or a designated contact of the store) that a packet was successfully sent to a potential customer, 1436.

FIG. 14B also illustrates an alternative embodiment that provides information back to the sender when the packet is reviewed. The packetshare manager module 414 detects the URL being accessed, it notifies the sender (system user) about the access, 1438. The user manager module 406 looks up the sender's contact information and preferred notification preferences, 1440. The notification may be sent, for example, through e-mail, 1442, text, 1444, instant message (not illustrated), or a combination of any of these (e.g., 1442, 1444).

In an alternative embodiment, the system further includes functionality to interact with the public directly. As mentioned previously, different companies or stores may limit the information that is available to the public conducting a search through the system. One approach to accomplishing this is with setting access rights to the different data categories based on the company or the store or any other factor that can be used to distinguish vehicles such as new versus used. In a further embodiment, the access level to information is further impacted by whether the person is registered with (or signed into) the system to provide tracking of who is receiving information.

In at least one embodiment, the method for providing information uses the method illustrated in FIG. 11A with the addition in at least one further embodiment of a limitation being placed on the data categories as discussed in the preceding paragraph. The resulting display would be similar to that depicted in FIG. 11B without the functionality present along the top of the interface (i.e., dashboard, packets, tools, and reports).

In a further embodiment, the searches are limited to participating companies and stores. In an alternative embodiment, the user is able to search within particular geographic regions or proximity to geographic regions/areas.

FIG. 15 illustrates an example of hierarchical structure within the system. The levels include the system 1500, a plurality of companies 1510, at least one store 1520 (car brand names are used for illustration purposes) associated with each company 1510, at least one store type 1532 and/or 1534 such as a new car department and a used car department associated with each store 1520, and different data categories 1542 (store data categories for new cars), 1544 (store data categories for used cars), 1546 (system data categories). In an alternative embodiment, the store data categories are the same for new and used cars while the system data categories are different based on the new car/used car distinction. It should be appreciated based on this disclosure the number of stores and companies can vary from what is illustrated in addition to these two levels being compressed into one level, particularly if the industry in which the system is implemented is better suited to one level; however, likewise the corporate levels could be more than two depending upon the industry in which the system is implemented.

The system 1500 has a set of users 1502 associated with it such as a system administrator, a company viewer, and a system content creator. The companies 1510 each will have a set of users 1512 associated with them including, for example, a company administrator, a store administrator, sales, a technician, and a content creator. In an alternative embodiment, the stores also have the capability to have users for their particular store. The mixture of users can vary between companies and/or stores and from what is shown in FIG. 15. In an alternative embodiment, the users have predefined roles for interacting with the system.

FIGS. 16A-16B illustrate an alternative embodiment of the system. The system 1600 includes an internal data receiver (or intake) 1602, an external data interface 1604, a database 1606, a file system storage 1608, and at least one programmed processor 1610. In an at least one embodiment, the internal data receiver 1602 and the external data interface 1604 are combined together as an intake module.

The internal data receiver 1602 and the external data interface 1604 provide connections to receive content. The internal data receiver 1602 as illustrated receives PDF (1612) and audiovisual (AV) (1614) files (e.g., images, sound recordings, videos) that are loaded into the system by users. Other types of content may be loaded by users via the system than that illustrated such as text files, other types of document files and HTML documents. Examples of particular types of documents that might be uploaded include: disclosure material, buyers guide, MPG, PDI, invoice, delivery receipt, vehicle title, window sticker, and a NADA file. The external data interface 1604 is illustrated as communicating with a variety of external systems such as NADA 1622, inventory systems 1624, service history depositories 1626, vehicle images 1628, and Kelley Blue Book (KBB) 1629. Other sources of content that are external to the system may communicate with the system 1600 through the external data interface 1604.

The database 1606 and the file system storage 1608 store the content of the system for use by the system and users. In at least one embodiment, the database 1606 is stored on a storage device as discussed in other parts of this disclosure. The file system storage 1608 stores the non-data records content of the system 1600. In at least one embodiment, the database 1606 and the file storage system 1608 reside on the same physical or logical drive.

The programmed processor(s) 1609 as illustrated in FIG. 16B operates according to a variety of code modules for processing and handling the content present in the system. In further embodiments, the modules discussed in other parts of this disclosure are also present on the programmed processor(s) 1609 in a variety of combinations.

FIG. 16A illustrates a variety of ways that users can access the system 1600 including, for example, e-mail 1642, MMS (or text) 1644, web browser 1646, and mobile platforms 1648.

FIGS. 17A-17F illustrate a collection of user interfaces to interact with the system through, for example, the dashboard module discussed previously. Based on the interfaces discussed in other parts of this disclosure, it should be understood that a header could be present along the top of these interface to provide menus, other user options, or contact information. Some of the information has been redacted to removing identifying information. Many of the illustrated interfaces include a search box 1701 to allow entry of a search term to locate a vehicle(s) associated with that store in the database. If the search is for a stock number, then an interface like that depicted in FIG. 11C may be produced while a search that returns multiple vehicles may produce an interface like that depicted in FIG. 11B.

FIG. 17A illustrates an example of how a list of packets that have been sent to customers may be displayed including identification of the team member (or salesperson) 1702, the customer (e.g., by name, e-mail or other electronic contact information) 1704, vehicle identifier 1706, vehicle make and model 1708, and when sent to the customer 1710. The checkmark 1712 identifies the packets that have been viewed by the customer. In at least one embodiment, if the cursor is placed over the checkmark information as to when the packet was last viewed is provided. The system in an alternative embodiment identifies external leads 1713.

FIG. 17B illustrates an alternative dashboard interface for displaying the information depicted in FIG. 17A. Instead of a checkmark being used to identify the packets that have been viewed, the view date and time is displayed 1712′. FIG. 17B also includes a listing of team members 1702 that includes the number of packets they sent 1714 and the number of times those packets have been viewed 1716 (although in an alternative embodiment, the viewed number represents the number of individual packets that have been viewed at least once). Also depicted in the interface is a pie chart 1718 showing the percentage of CPO and non-CPO vehicles in inventory. Other information could be portrayed in the pie chart including percentage using a variety of characteristics such as new, used, make, model, year, etc. The bar graph 1720 provides some historical information regarding inventory, but it also could be used to convey a variety of other information much like the illustrated pie chart 1718. Based on this disclosure, it should be understood that a variety of graphs or tabular information could be displayed in place of that illustrated in FIG. 17B.

FIG. 17C illustrates an example of an interface that displays a list of vehicles and which data categories 1724 are available for each vehicle listed. The vehicles are identified by stock number 1706, year 1722, and make and model 1708. In this particular illustration, if a vehicle has a particular data category 1724 the field is blank, but if a particular data category is not present in the database for that vehicle, then the field includes a “X” or other mark. It should be understood that other indicia could be used.

FIG. 17D illustrates an example of an interface that displays a list of vehicles including their days in inventory 1726 based on when the store's source indicates the vehicle entered inventory and then a series of columns 1728 showing the number of packets sent out over time.

In an alternative embodiment, the vehicles also serve as links to allow the user to view the packet associated with the vehicle.

FIG. 17E illustrates an example of an interface that displays packet sent information, which was reached by the selection of “Sent history” 1730 on the interface for a vehicle, for one vehicle, which is identified 1734 on the display, that identifies the customer 1704, the salesperson 1704, the date sent 1710, and whether the packet has been viewed 1712. Also offered as viewing options include an optional “More” link 1731 for submitting a problem report, an optional “Print” link 1732 for printing the packet, a “Send” link 1733 for sending the packet to a customer that displays an interface like that depicted in FIG. 12B, and a “Packet” link 1733 to display an interface like that depicted in FIG. 11C.

Previously there was a discussion regarding financing rates, FIG. 17F illustrates an example of an interface that can be used to adjust finance rates through the “Edit” links 1736 along with displaying a table 1738 with the applicable current rates and applicability that are available assuming appropriate creditworthiness of the customer. FIG. 17F also illustrates that if the logged in user has access to multiple stores, then can use the pull-down menu 1740 to change the store.

FIG. 17B also illustrates an alternative interface in terms of accessing information in the database by vehicle type such as car, crossover, SUV, truck, and van. In at least one further embodiment, these are pull down menus that provide options based on the current inventory for the store. Other examples of pull down menus that can be used like this include: type, make, model, and certified pre-owned or not as illustrated, for example, in FIG. 11B. In at least one embodiment, these menus are dynamically configured based on the current inventory for the store. In at least one embodiment the packet module and/or report module 431 provide the frontend for this dynamic interface with the packet manager module 412 and vehicle manager module 420 providing the backend support.

Based on this disclosure, it should be appreciated by those of ordinary skill in the art that the system and method can be adapted for use in other industries.

The first example is the real estate field, where instead of vehicles being sold it would be real estate being sold or rented. The various data categories could be a description with price information and/or images or other audiovisual files; floor plans; warranty information; reports relating to the infrastructure of the house such as the roof, appliances, temperature control units, etc.; disclosure materials either legal disclosures and/or home owner association information and material; documents relating to community amenities; public transportation information; financing information and/or requirements; and third party report regarding valuation of the property such as appraisal information and/or Government assessment information. The real estate field implementation may include residential and office markets.

The second example is the vehicle customization field. Vans, trucks, buses, or recreational vehicles (RVs) are often customized by adding one or more external components. A separate data category could be created for each component that is added or customized on the vehicle. Design specifications, parts list, bills of materials, invoices and photos could all be organized as a “packet” and shared with prospective customers or provided at the sale of the vehicle.

As will be appreciated by one skilled in the art based on this disclosure, aspects of the present invention may be embodied as a system, method or computer program product. Accordingly, aspects of the present invention may take the form of an entirely hardware embodiment, a processor operating with software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this disclosure, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer program code for carrying out operations for aspects of the present invention may be written in any combination of one or more programming languages, including an object oriented programming language such as Java, Smalltalk, C++, C#, Transact-SQL, XML, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring now to FIG. 18, a representative a hardware environment for practicing at least the first embodiment of the invention is depicted. This schematic drawing illustrates a hardware configuration of an information handling/computer system in accordance with at least one embodiment of the invention. The system comprises at least one processor or central processing unit (CPU) 1810. The CPUs 1810 are interconnected with system bus 1812 to various devices such as a random access memory (RAM) 1814, read-only memory (ROM) 1816, and an input/output (I/O) adapter 1818. The I/O adapter 1818 can connect to peripheral devices, such as disk units 1811 and tape drives 1813, or other program storage devices that are readable by the system. The system can read the inventive instructions on the program storage devices and follow these instructions to execute the methodology of at least one embodiment of the invention. The system further includes a user interface adapter 1819 that connects a keyboard 1815, mouse 1817, speaker 1824, microphone 1822, and/or other user interface devices such as a touch screen device (not shown) to the bus 1812 to gather user input. Additionally, a communication adapter 1820 connects the bus 1812 to a data processing network 1825, and a display adapter 1821 connects the bus 1812 to a display device 1823 which may be embodied as an output device such as a monitor, printer, or transmitter, for example

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Although the present invention has been described in terms of particular example embodiments, it is not limited to those embodiments. The embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. A method for assimilating information for a plurality of vehicles from a plurality of sources to present to at least one person using a system having at least one processor and a relationship database, the method comprising:
searching the relationship database for active vehicles;
for each vehicle:
determining whether the relationship database has images for the located vehicle;
when a vehicle has no images associated with it, querying the relationship database for a source and obtaining images if available from that source;
determining whether the vehicle is a certified pre-owned vehicle;
when a vehicle is a certified pre-owned vehicle, loading a set of data categories for certified pre-owned vehicles into an array to perform an iterative loop through that array to obtain and/or update information in those data categories;
querying the relationship database for system data categories to load into a second array to perform an iterative loop through that array to obtain and/or update information in those data categories;
querying the relationship database for data categories for a dealership associated with the vehicle to load into a third array to perform an iterative loop through that array to obtain and/or update information in those data categories including retrieving any stored content to create presentation material using predefined templates.

2. The method according to claim 1, wherein the iterative loop for any of the arrays includes
looping through that array from 1 to n where n equals the number of data categories in that array,
for each loop
determine whether that array end has been reached, when that array end is reached progressing to the next query step or end of said method;
querying the relationship database to determine if content is present for the data category;
when no content is present in the relationship database, retrieving content from a source, storing the content into the relationship database and/or the file system then returning to the start of the loop;
when content is present in the relationship database, determining whether there is newer content available;
when newer content is available, retrieving newer content from a source, storing the newer content into the relationship database and/or the file system then returning to the start of the loop; and
when newer content is not available, returning to the start of the loop.

3. The method according to claim 2, wherein when there is newer content available, further archiving the previous content.

4. The method according to claim 1, wherein the system data categories include basic data categories and complex data categories,
where complex data categories use the pre-defined templates.

5. The method according to claim 1, further comprising:
retrieving an inventory data feed from an external source;
reviewing each vehicle in the inventory data feed;
for each vehicle
determining whether the data formats are equivalent;
when the data formats are not equivalent, translating the unequal data formats;
determining whether the vehicle is present in the relationship database;
when the vehicle is not present, assigning a new identification for the vehicle and creating a record for the vehicle in the relationship database, then proceeding to the next vehicle in the inventory data feed;
when the vehicle is present, determining whether the data values are equal;
when the data values are not equal, determining which data value to use, then proceeding to the next vehicle in the inventory data feed; and
when the data values are equal, then proceeding to the next vehicle in the inventory data feed.

6. The method according to claim 1, further comprising:
receiving a request for vehicle information;
determining whether the request includes a vehicle identifier;
when multiple identifiers are received, submitting multiple queries to the relationship database using the possible vehicle identifiers and joining the query results together;
when a single identifier is received, submitting a single query to the relationship database;
determine whether more than one vehicle has been located;
when more than one vehicle is located, displaying an inventory page including the located vehicles and receiving a selection from the user of one vehicle; and
when one vehicle is located or selected, then
loading any data categories into a loop array, and
looping over the loop array to return content to a user interface with a label for each data category that is available and includes content.

7. The method according to claim 6, wherein looping over the loop array includes checking whether there is another data category in the loop array before terminating the loop when an end of the loop array is reached.

8. The method according to claim 1, further comprising:
receiving a user selection of a selected vehicle for communication of a packet to a third party;
querying the relationship database to learn available data categories for the selected vehicle and providing the available data categories to the user for selection;
receiving contact information for the third party and a selection of data categories to send to the third party as part of the packet;
validating the contact information;
looping over a packet array containing the selected data categories;
for each data category
retrieving any data for the data category,
retrieving content present in the file system for data categories having file system content and merging the content into the packet, and
proceeding to next data category in the packet array if any; and
sending the packet to the third party.

9. The method according to claim 8, wherein if validation fails, informing the user of an error and returning to receiving contact information.

10. The method according to claim 8, further comprising adding a data record into a data table in the relationship database after the packet is sent and the third party the packet was sent to for use in analytical reports.

11. The method according to claim 1, further comprising receiving and locating content in the relationship database and the file system based on any combination of the following: vehicle identification number, dealership stock number, make, and model.

12. A method for assimilating information for a plurality of vehicles from a plurality of sources to present to at least one person using a system having at least one processor and a relationship database, the method comprising:
searching the relationship database for active vehicles;
for each vehicle querying the relationship database for data categories to load into an array to perform an iterative loop through that array to get and/or update information in those data categories;
wherein the iterative loop includes
looping through the array from 1 to n where n equals the number of data categories in the array,
for each loop
determine whether the array end has been reached, when the array end is reached progressing to the next query step or end of said method;
querying the relationship database to determine if content is present for the data category;
when no content is present in the relationship database, retrieving content from a source, storing the content into the relationship database and/or the file system then returning to the start of the loop;
when content is present in the relationship database, determining whether there is newer content available;
when newer content is available, retrieving newer content from a source, storing the newer content into the relationship database and/or the file system then returning to the start of the loop; and
when newer content is not available, returning to the start of the loop.

13. The method according to claim 12, wherein when there is newer content available, further archiving the previous content.

14. The method according to claim 12, wherein the data categories include basic data categories, complex data categories, dealership data categories, and certified pre-owned data categories.

15. The method according to claim 12, further comprising:
retrieving an inventory data feed from an external source;
reviewing each vehicle in the inventory data feed;
for each vehicle
determining whether the data formats are equivalent;
when the data formats are not equivalent, translating the unequal data formats;
determining whether the vehicle is present in the relationship database;
when the vehicle is not present, assigning a new identification for the vehicle and creating a record for the vehicle in the relationship database, then proceeding to the next vehicle in the inventory data feed;
when the vehicle is present, determining whether the data values are equal;
when the data values are not equal, determining which data value to use, then proceeding to the next vehicle in the inventory data feed; and
when the data values are equal, then proceeding to the next vehicle in the inventory data feed.

16. The method according to claim 12, further comprising:
receiving a request for vehicle information;
determining whether the request includes a vehicle identifier;
when multiple identifiers are received, submitting multiple queries to the relationship database using the possible vehicle identifiers and joining the query results together;
when a single identifier is received, submitting a single query to the relationship database;
determine whether more than one vehicle has been located;
when more than one vehicle is located, displaying an inventory page including the located vehicles and receiving a selection from the user of one vehicle; and
when one vehicle is located or selected, then
loading any data categories into a loop array, and
looping over the loop array to return content to a user interface with a label for each data category that is available and includes content.

17. The method according to claim 12, further comprising:
receiving a user selection of a selected vehicle for communication of a packet to a third party;
querying the relationship database to learn available data categories for the selected vehicle and providing the available data categories to the user for selection;
receiving contact information for the third party and a selection of data categories to send to the third party as part of the packet;
validating the contact information;
looping over a packet array containing the selected data categories;
for each data category
retrieving any data for the data category,
retrieving content present in the file system for data categories having file system content and merging the content into the packet, and
proceeding to next data category in the packet array if any; and
sending the packet to the third party.

18. A system for vehicle information input, storage, and retrieval where the vehicle is for sale at a dealership comprising:
a relationship database;
means for data collection from a plurality of sources including third party data resources, the vehicle manufacturer's computer system, a dealership management system, and a dealership's website hosting provider;
means for data normalization of data obtained from the plurality of sources so that the data can be stored in the relationship database and associated with at least one vehicle;
means for data aggregation and storage in the relationship database using a plurality of keys to define relationships between data records and associating files to at least one data record;
means for data presentation to a user of the data associate with at least one vehicle; and
means for data communication of an information packet to potential consumers where the informational packet includes information regarding one vehicle that is selected by the user.

19. The system according to claim 18, wherein the data sent to one of the potential consumers has information about a vehicle obtained from a dealership management system or vendor of the dealership including information retrieved from a vehicle manufacturer's computer systems, a vehicle on-board computer, service history data, ownership history data, warranty data, original factory equipment data, invoice pricing data, vehicle images, financing data, current retail value data, vehicle description, inspection report, repair order history, disclosure report, warranty information, retail reports, history reports, MSRP, financing options, and dealership information.
